(19) United States
(12) Patent Application Publication
(10) Pub. No.: US 2025/0178120 A1
(43) Pub. Date: Jun. 5, 2025

(54) METHOD FOR DIFFUSION BONDING NICKEL ALLOYS AND AUSTENITIC STAINLESS STEEL

(71) Applicant: Daniel Grodek, Columbus, OH (US)

(72) Inventor: Daniel Grodek, Columbus, OH (US)

(21) Appl. No.: 18/965,687

(22) Filed: Dec. 2, 2024

Related U.S. Application Data
(60) Provisional application No. 63/604,429, filed on Nov. 30, 2023.

(51) Int. Cl. B23K 20/02; B23K 20/06; B23K 20/14; B23K 103/04; B23K 103/08; B23K 103/18

(52) U.S. Cl. CPC B23K 20/026; B23K 20/06; B23K 20/14; B23K 2103/05; B23K 2103/08; B23K 2103/26

(57) ABSTRACT

The present invention discloses a method of diffusion bonding of nickel alloy and austenitic stainless steel materials. The method involves: heating a bonding interface of the materials by induction heating at a temperature range in an austenitic temperature region under controlled atmospheric pressure; applying a bonding pressure to maintain contact between materials during a bonding process of materials; cooling the bonded materials through specific time frames to ensure proper chemical interactions and minimize defects, and shielding a bonding environment using a controlled ambient atmosphere to reduce impurities, and prevent oxidation and corrosion. The method further involves forming and shaping subcomponents of stainless steel and nickel alloys.

### CROSS-REFERENCE TO RELATED APPLICATIONS

This application claims the benefit of priority under 35 U.S.C. § 119 (e) to U.S. Patent Application Provisional Application Ser. No. 63/604,429, entitled “FORMING-DIFFUSION OF NICKEL AND/OR STAINLESS STEEL ALLOYS PROCESSES,” filed Nov. 30, 2023, the contents of which are hereby incorporated by reference in their entirety for any purpose.

### TECHNICAL FIELD

The present disclosure relates generally to a diffusion-bonded metallic materials, and more particularly, a method for diffusion bonding nickel alloys and austenitic stainless steel.

### BACKGROUND

Diffusion bonding is a process that involves applying heat and pressure to components, encouraging atomic diffusion to create a strong metal bond between them. However, certain materials, such as nickel alloys and austenitic stainless steels, pose challenges in high-temperature environments. At elevated temperatures, the materials can undergo unwanted reactions at their interfaces, such as carbide formation and the development of precipitates, which compromise their strength and durability. Precipitates add strength, control carbides, and will limit dislocations leading to cracks.

Additionally, precise control of the temperature and diffusion process is crucial to avoid excessive phase changes and ensure that the bonding process occurs within the desired temperature range. If the temperature is too high, the materials may lead to unwanted phase changes, such as the melting or decomposition of certain phases, which could weaken the bond or cause material degradation. On the other hand, if the temperature is too low, diffusion may not occur at an optimal rate, leading to weak or incomplete bonding of the materials. Therefore, maintaining the bonding process within a specific temperature range is crucial to achieve the desired material properties. This helps avoid the formation of undesirable phases, such as carbides or precipitates, which can negatively affect the strength and integrity of the final bond, especially under high-temperature or stressful operating conditions. The complexity of managing the chemical reactions and maintaining material integrity requires an advanced approach to optimize the bonding and ensure long-term performance in demanding applications, such as nuclear systems.

Therefore, there is a need for a diffusion bonding method and system that enables the creation of strong, reliable bonds between nickel alloys and austenitic stainless steels for high-temperature applications, such as nuclear systems. The method needs to optimize the diffusion process to ensure the formation of a durable bond while preventing issues like carbide formation and the development of precipitates at the material interfaces. The method needs to allow for precise control of temperature, diffusion, and energy to achieve uniform bonding. Additionally, the method and system need to minimize oxidation and other undesired reactions, ensuring the sustainability and strength of the materials over their lifecycle. The system needs to meet the demanding performance standards required for high-temperature and nuclear applications, ensuring long-term reliability and integrity of the components.

### SUMMARY OF THE INVENTION

The present invention has been made in another effort to provide austenitic stainless steel and a manufacturing method thereof for improving mechanical characteristics including high-temperature strength of austenitic stainless steel.

The present invention discloses a method of diffusion bonding of nickel alloy and austenitic stainless steel materials. At one step, a bonding interface of the materials is heated by induction heating at a temperature range in an austenitic temperature region under controlled atmospheric pressure. In one embodiment, the materials are heated at a temperature range between 1150° C. and 1300° C. (2100° F. to 2350° F.). Induction heating is performed using at least one of AC inductance and pulse-width modulation system through voltage control.

In one embodiment, the subcomponents of stainless steel and nickel alloys are formed and shaped. The forming and shaping of subcomponents of stainless steel and nickel alloys involves: providing one or more layers of stainless steel and nickel alloy materials with predetermined thickness ratios to form the subcomponents; applying inductance heating to elevate the temperature of the bonding interface to austenitic ranges; utilizing one or more mechanical systems to shape and form the subcomponents into a desired geometry during or after the bonding process; maintaining a controlled atmosphere to prevent contamination during the forming and bonding process; using ceramic inserts to ensure dimensional precision during the forming process, and aligning and coating with ceramics for regions being held to specific dimensional criteria.

At yet another step, the bonded materials are cooled through specific time frames to ensure proper chemical interactions and minimize defects. At yet another step, a bonding environment is shielded using a controlled ambient atmosphere to reduce impurities, and prevent oxidation and corrosion. In one embodiment, the bonding environment is shielded using at least one of gas atmosphere, vacuum, and mechanical enclosures. In one embodiment, the shielding gas is selected from argon, hydrogen, nitrogen, CO₂ or mixtures thereof.

At yet another step, one or more intermediate layers are disposed between the boding interfaces of the material to be joined to control thermal gradients and heat transfer direction before the step of heating the bonding interface. The intermediate layer is formed from additional bonding elements. Commercial use of 308L and 309L stainless steel alloys in the form of sheet metal or powder, can be used to enhance diffusion and minimize carbide formation.

In a prior step, chemical ranges of the materials are controlled to reduce carbides and control alloying elements and precipitates. After diffusion, cooling rates are controlled to regulate carbide formation and precipitate patterns at the bonded interface. In one embodiment, the cooling rate is controlled through programmable thermal systems to transition the materials through stable regions of the phase diagram, thereby minimizing residual stresses and improving bond strength. The regulation of carbide and precipitate formation involves steps of: selecting shielding gases and adjusting atmospheric conditions to control nucleation at high temperatures; regulating cooling rates to transition through carbide-sensitive regions of the phase diagram; and applying energy through induction heating to ensure uniform diffusion and mitigate localized defects. At yet another step, the materials are maintained within a stable phase region during the bonding process utilizing phase diagrams.

In one embodiment, the mechanical systems include a combination of hydraulic presses, forging presses, and electromagnetic fixtures to apply controlled pressure during the bonding process. In one embodiment, the subcomponents are formed using at least one of hot forging processes, cold forming and hydroforming process. In one embodiment, at least one of pulse width modulation (PWM) and frequency control is performed using digital programmable logic controllers (PLCs) to regulate the heating system across multiple inductance circuits, creating electrical offsets that adjust energy delivery to specific areas at or around the interface. Multiple inductance coils or voltage tubes can be used in series across an offset. Wiring a primary inductance coil and series of offset voltage tubes can allow for uniform heating directed at patterns of regions. In yet another step, post-bonding quality checks are performed using at least one of radiographic analysis and non-destructive testing methods.

The treatment according to the invention may be applied to a very large number of parts and especially to any mechanical part subjected to wear in a corrosive medium. For example, the invention may be applied advantageously to the production of equipment used in the field of the food industry, the chemical industry, the iron and steel industry, the nuclear industry or the car industry, or to the production of equipment used in a marine environment or in biomedical applications.

### BRIEF DESCRIPTION OF THE DRAWINGS

FIG. 1 exemplarily illustrates a method for diffusion bonding of nickel alloy and austenitic stainless steel, according to an embodiment of the present invention.

FIG. 2 exemplarily illustrates a method for diffusion bonding of nickel alloy and austenitic stainless steel, according to another embodiment of the present invention.

FIG. 3 is a table of comparison of the chemical compositions of inconel, 316L stainless steel, and an additional alloying layer used in the diffusion bonding process, according to an embodiment of the present invention.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the order discussed or illustrated, unless specifically identified as an order of performance. It is also to be understood that additional or alternative steps may be employed.

When an element or layer is referred to as being “on,” “engaged,” “connected,” or “coupled” to or with another element, it may be directly on, engaged, connected or coupled to the other element or layer, or intervening elements or layers may be present. In contrast, when an element is referred to as being “directly on,” “directly engaged to,” “directly connected to,” or “directly coupled to” or with another element or layer, there may be no intervening elements or layers present Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath.” “below,” “lower,” “above,” “upper,” and the like, may be used herein for ease of description to describe one element or feature's relationship to another element(s) or feature(s) as illustrated in the figures Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

“Substantially” is intended to mean a quantity, property, or value that is present to a great or significant extent and less than, more than or equal to total. For example, “substantially vertical” may be less than, greater than, or equal to completely vertical.

“About” is intended to mean a quantity, property, or value that is present at +10%. Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range, including endpoints given for the ranges.

Recitation of ranges of values herein are merely intended to serve as a shorthand method of referring individually to each separate value falling within the recited range, unless otherwise indicated herein, and each separate value is incorporated into the specification as if it were individually recited herein.

References to “embodiment” or “variant”, e.g., “one embodiment,” “an embodiment,” “example embodiment,” “various embodiments,” etc., may indicate that the embodiment(s) or variant(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment or variant, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### Definitions

Austenite: Austenite steel, also known as austenitic stainless steel, is a type of steel with a face-centered cubic (FCC) crystalline structure and generally comprises more than 8% nickel content, which is stable at high temperatures and critical for processes like diffusion bonding. The minimum amount of nickel that can stabilize the austenitic structure at room temperature is around 8 percent. In some embodiments, the austenitic stainless steel may contain about 8 to 22 wt. % of nickel (Ni). In some embodiments, the austenitic stainless steel may contain 12 to 26 wt. % of chromium (Cr). The austenitic stainless steel may have an austenite matrix. In some embodiments, the austenitic stainless steel may contain uniformly distributed nanosized precipitates. In some embodiments, the austenitic stainless steel includes about 0.02 to 0.1 wt. % of carbon (C). In some embodiments, the austenitic stainless steel includes about 2 to 3.5 wt. % of manganese (Mn). In some embodiments, the austenitic stainless steel includes about 0.5 to 1.5 wt. % of molybdenum (Mo). In some embodiments, the austenitic stainless steel may include greater than 0 wt. % and equal to or less than about 0.3 wt. % of silicon (Si). In some embodiments, the austenitic stainless steel may include greater than 0 wt. % and equal to or less than about 0.01 wt. % of phosphorus (P) and greater than 0 wt. % and equal to or less than about 0.01 wt. % of sulfur(S).

Chromium is a key alloying element in stainless steels. More than 10.5 percent needs to be added to steel to allow the protective oxide film to form that provides its corrosion resistance Austenitic stainless steels and similar alloys. For example, SAE 301, 301L, 304, 304L, 305, 316, 316E and AM 355, generally have chromium contents ranging from 12 to 18%.

Bonding process: Bonding process refers to a method used to join two or more materials through diffusion, heat, pressure, or a combination of these mechanisms to create a cohesive interface.

Bonding environment: Bonding environment refers to the controlled atmosphere or setting in which the bonding process occurs, designed to minimize impurities, oxidation, and contamination.

Carbides: Carbides refers to a class of chemical compounds in which carbon is combined with a metallic or semi-metallic element, often creating hard and wear-resistant materials. Chromium carbide forms in austenitic steel at temperatures around 1,000° F. and above. However, the rate of carbide formation decreases above 1,200° F. because the chromium carbide begins to redissolve in the austenite. Nickel promotes the precipitation and growth of carbides.

Chemical ranges: Chemical ranges refer to the specified compositional limits for alloying elements in a material, often verified by spectrographic analysis to ensure quality compliance.

Diffusion: Diffusion refers to the exchange of atoms or molecules between materials, resulting in their bonding or mixing at the interface. “Diffusion layer” as used herein, refers to the melted zone between erosion shield material deposited by a fusion process. This diffusion layer represents the intermixing of two or more materials.

Induction heating is the process of heating electrically conductive materials, namely metals or semi-conductors, by electromagnetic induction, through heat transfer passing through an inductor that creates an electromagnetic field within the coil to heat up metals. The heat is generated inside the object itself, instead of by an external heat source via heat conduction. Thus, objects can be heated very rapidly without any external contact.

Hot forging: Hot forging refers to a mechanical forming process that involves heating materials to reduce residual stresses and improve their malleability for shaping.

Nickel alloys: Nickel alloys refer to metals with a high nickel content, known for their corrosion resistance and strength at elevated temperatures. In one embodiment, the nickel alloy has an average grain size smaller than approximately 9 microns. Example nickel-based alloys contain nickel as the most prevalent element in the alloy, measured by atomic percent or weight, such as commercially pure nickel, nickel-copper, nickel-chromium, nickel-chromium-iron, nickel-chromium-molybdenum, nickel-molybdenum, HASTELLOY® alloys (i.e., nickel-chromium containing alloys, available from Haynes International), INCONEL® alloys austenitic nickel-chromium containing superalloys available from Special Metals Corporation), WASPALOYS® (i.e., austenitic nickel-based superalloys), RENE® alloys (i.e., nickel-chromium containing alloys available from Altemp Alloys, Inc.), HAYNES® alloys (i.e., nickel-chromium containing superalloys available from Haynes International), MP98T (i.e., a nickel-copper-chromium superalloy available from SPS Technologies), TMS alloys, CMSX® alloys (i.e., nickel-based superalloys available from C-M Group). XM-19 stainless steel was designed to have controlled chemistry ranges as an example of limiting chemistry range to improve carbide control through inductance and bonding between nickel alloys and stainless steel using 308L and 309L intermediate.

Phase diagram: Phase diagram refers to a graphical representation of experimental data showing phase changes of a material across different chemical compositions and temperature ranges.

Pulse width modulation (PWM) is a digital technique that controls a signal by repeatedly switching it between high and low states in a consistent pattern. PWM is used to control the average power or amplitude of an electrical signal. Wider pulses result in a higher average input voltage, while narrower pulses result in a lower input voltage. The two key parameters of a PWM signal are frequency and duty cycle. The duty cycle is the ratio of the turn-on time to the total time period. There are three common types of PWM techniques: Trail Edge Modulation, Lead Edge Modulation, and Pulse Center Two Edge Modulation. PWM in inductance heating allows for precise heating of metal components.

Shielding gas: Shielding gas refers to a gas used to create an inert atmosphere around a material during processing to prevent oxidation and contamination

Stainless steels: Stainless steels refer to metals with a specified range of chromium to minimize corrosion, including austenitic stainless steels, duplex stainless steels, and nuclear-grade specialty steels such as XN grades. Stainless steels are a group of alloys based on iron, nickel and chromium as the major constituents, with additives that can include carbon, tungsten, niobium, titanium, molybdenum, manganese, and silicon to achieve specific structures and properties. The major types are known as martensitic, ferritic, duplex and austenitic steels. Austenitic stainless steel generally is used where both high strength and high corrosion resistance is required. One group of such steels is known collectively as high temperature alloys (HTAs) and is used in industrial processes that operate at elevated temperatures generally above 650° C. and extending to the temperature limits of ferrous metallurgy at about 1150° C. The major austenitic alloys used have a composition of iron, nickel or chromium in the range of 18 to 42 wt. % chromium, 18 to 48 wt. % nickel, balance iron and other alloying additives. Typically, high chromium stainless steels have about 31 to 38 wt. % chromium and low chromium stainless steels have about 20 to 25 wt. % chromium.

The terms “unavoidable impurities” or “accidental impurities” have a meaning known to those skilled in the art and are widely used in this field of the technique. Examples of such unavoidable impurities are sulphur(S), phosphorous (P), copper (Cu), alkali metals and alkaline-earth metals.

### DESCRIPTION OF EXEMPLARY EMBODIMENTS

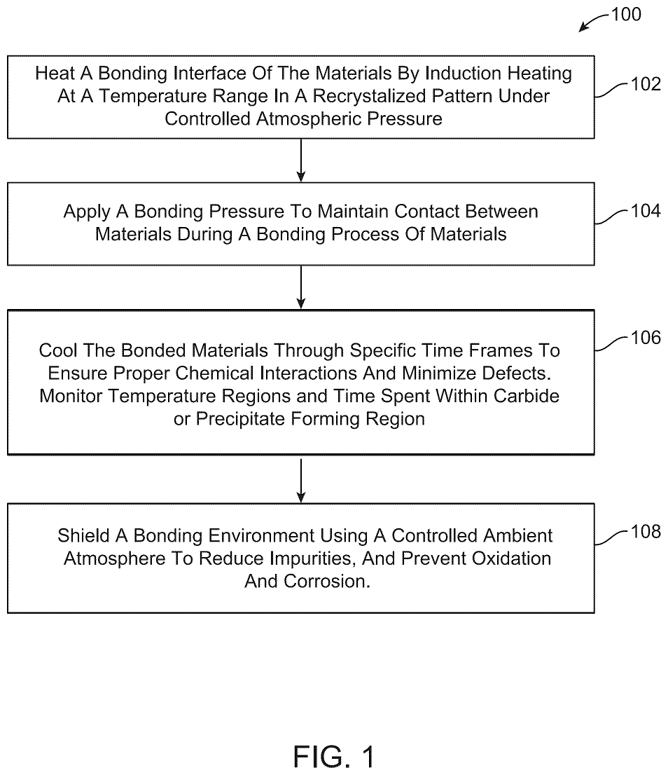

FIG. 1 exemplarily illustrates a method 100 for diffusion bonding of nickel alloy and austenitic stainless steel, according to an embodiment of the present invention. At step 102, a bonding interface of the nickel alloy and austenitic stainless steel materials is heated by induction heating. The alloys are heated or reheated into the Austenite region (γ), which helps to relieve residual stresses in the materials. In one embodiment, the materials are heated to a temperature range between 1150° C. and 1300° C. (2100° F. to 2350° F.) in an austenitic temperature region under controlled atmospheric pressure. In one embodiment, the peak temperature range for the method is between 1150 to 1300° C. (or 2100 to 2350° F.) at 1 atm. The diffusion bonding between austenitic stainless steel and nickel alloys primarily occurs in the austenitic temperature region. Nickel alloy phase diagrams could be used to ensure that the materials do not exceed their melting temperatures during the process.

In one embodiment, the steel or nickel having a low carbon content and a high carbide-forming elements content may be chosen from stainless steels such as the 300 series austenitic stainless steels and INCOLOY® Alloy 800 or from nickel alloys such as Inconel®, Haynes®, or Hastelloy® type alloys. In one embodiment, the stainless steel is selected from the group consisting of SAE 301, 301L, 304, 304L, 305, 316, 316L and AM 355.

In one embodiment, the austenitic stainless steel comprising an austenitic stainless steel comprising 16 to 18 wt. % of chromium (Cr) and 10 to 15 wt. % of nickel (Ni). In one embodiment, the austenitic stainless steel may further include equal to or less than 0.03 wt. % of carbon (C) and equal to or less than 2 wt. % of manganese (Mn). In another embodiment, the austenitic stainless steel may further include 0.5 to 3 wt. % of molybdenum (Mo). In another embodiment, the austenitic stainless steel may further include equal to or less than 0.3 wt. % of silicon (Si). In another embodiment, the austenitic stainless steel may further include equal to or less than 0.045% wt. % of phosphorus (P) and equal to or less than 0.03 wt. % of sulfur(S).

In another embodiment, the austenitic stainless steel comprises in combination, not more than 0.035% carbon; 16.0% to 18.0% chromium; 10.0% to 15.0% nickel; 2.0% to 3.0% molybdenum; not more than 2.0% manganese; not more that 1.0% silicon; with the remainder substantially all iron. In another embodiment of the invention, the austenitic stainless steel comprises in combination, not more that 0.035% carbon; 18.0% to 20.0% chromium; 8.0% to 13.0% nickel; not more than 2.0% manganese; not more than 1.0% silicon; and the remainder substantially all iron.

In one embodiment, the bonding interface is heated by using electromagnetic radiation through AC inductance or PWM with a feedback control loop. In another embodiment, electrical offsets of ideal phase power can be used in place of pulse wave modulation with close accuracy. Inductance from a geometrically-symmetrical voltage tube from within the interior of the die or tool, which can be utilized to have a uniform heating pattern.

Digital Inductance is used to control heat input to create energy density in specific areas of the subcomponent layers or region of steel. In one embodiment, the intermediate layer contains a minimum of 0.75% by wt. % copper at the interface and will exhibit strengthening and sustainability. The nickel layer will exhibit dilution into the interface of carbon and aluminium creating carbide (from nickel and chromium) as well as aluminium precipitates. Maximum heat input in KJ/min can be used for a given thickness of material. For 316L, this will ensure a minimum tensile strength of 35 MPa including the chemistry ranges shown in Table 1.

TABLE 1

| Elements | Wt. Percent |
|---|---|
| Carbon (C) | .030 |
| Chromium (Cr) | 16-18% |
| Iron (Fe) | 61.9-72% |
| Manganese (Mn) | <=2.0% |
| Molybdenum (Mo) | 2.0-3.0 |
| Nickel (Ni) | 10-14% |
| Phosphorus (P) | <=.045% |
| Silicon (Si) | <=1.0% |
| Sulfur (S) | <=.030% |

Macro cross sectional examination can confirm limited dislocation, and no cracking based on grain size. Visible carbides under microscopic examination can guarantee inductance into specific regions, through pulse width modulation (PMW) and heat input control to carbides and precipitates.

The control of heat transfer during the diffusion bonding process can be precisely managed using inductance. By applying additional energy through inductance, the system can regulate the cooling rate, enabling delayed and continuous cooling or tempering of the materials. This controlled cooling ensures a gradual reduction in temperature, preventing thermal stresses and improving the microstructure of the bond. To achieve this level of precision, pulse width modulation (PWM) or frequency control is employed, utilizing digital programmable logic controllers (PLCs). These controllers manage the electrical currents across a specially designed circuit. In this setup, multiple lines operate in parallel to handle inductance, which helps distribute energy evenly across the interface. The process also introduces electrical offsets, which further refine energy delivery, ensuring that heat transfer remains consistent and tailored to the specific requirements of the materials being bonded.

In one embodiment, the bonding interface of the materials is heated by induction heating at a temperature range in an austenitic temperature region. In another embodiment, the bonding interface heat treatment is progressed for 30 minutes to 2 hours at a temperature of 1150 to 1300° C. In another embodiment, the bonding interface heat treatment is at a temperature of 1150 to 1260° C. In another embodiment, the bonding interface heat treatment is at a temperature of 1200 to 1300° C. In one embodiment, the materials are heated at a temperature of at least 900, 950, 1000, 1050, 1100, 1150° C. or more. In another embodiment, the materials are heated at a temperature of at most 1300, 1275, 1260° C. or less.

In one embodiment, the bonding interface heat treatment is progressed for 10 minutes to 6 hours. In another embodiment, the bonding interface heat treatment is progressed for 15 minutes to 5 hours. In another embodiment, the bonding interface heat treatment is progressed for 30 minutes to 4 hours. In one embodiment, the bonding interface heat treatment is progressed for at least 5, 10, 15, 20, 25, 30 minutes or more. In another embodiment, the bonding interface heat treatment is progressed for at most 6, 5, 4, 3, 2, 1 hours or less.

At step 104, a bonding pressure is applied to maintain contact between materials during a bonding process of materials. Shielding gas pressure differences can provide overall force differences across entire surfaces. Pressure differences based on locations of the shielding gas purge and adjacent subcomponent or alloy layer. The ideal gas law calculations within a defined reference frame will align with total radiation energy losses through deltaH of conduction. Reactive gases will have bonding energy, alpha and beta particle, or radiation transfer.

In one embodiment, the bonding pressure applied between materials during the bonding process is at a pressure greater than 0 MPa. In another embodiment, the bonding pressure applied between materials during the bonding process is at a pressure from 0.1 MPa to 200 MPa. In another embodiment, the bonding pressure applied between materials during the bonding process is at a pressure from 1 MPa to 100 MPa. In another embodiment, the bonding pressure applied between materials during the bonding process is at a pressure from 1 MPa to 10 MPa. In another embodiment, the diffusion bonding includes hot isostatic pressing at about 50 MPa to 150 MPa. pressure.

At step 106, the bonded materials are cooled through specific time frames to ensure proper chemical interactions and minimize defects. Temperature regions and time spent within a carbide or precipitate forming region will be monitored. Cooling through the correct regions while limiting specific alloying elements, especially carbon, can control the carbide formations.

At step 108, a bonding environment of the bonding process is shielded using a controlled ambient atmosphere. In one embodiment, the bonding environment is shielded introducing shielding gas in the bonding environment. The shielding gas creates an inert or controlled atmosphere around the material, ensuring that harmful reactions (such as oxidation or corrosion) do not occur during heating, diffusion bonding, or other high-temperature processes. The shielding gases are used to control the reaction through thermodynamics and prevent or reduce any oxidizers. Excess material removal and surface finish of stainless steel can be processed with no adverse effects. Nickel alloy can absorb elements into precipitates. The absorption of precipitation elements throughout the nickel alloy are beneficial near interface or intermediate fusion region and a surface finish may reduce strength at elevated temperature.

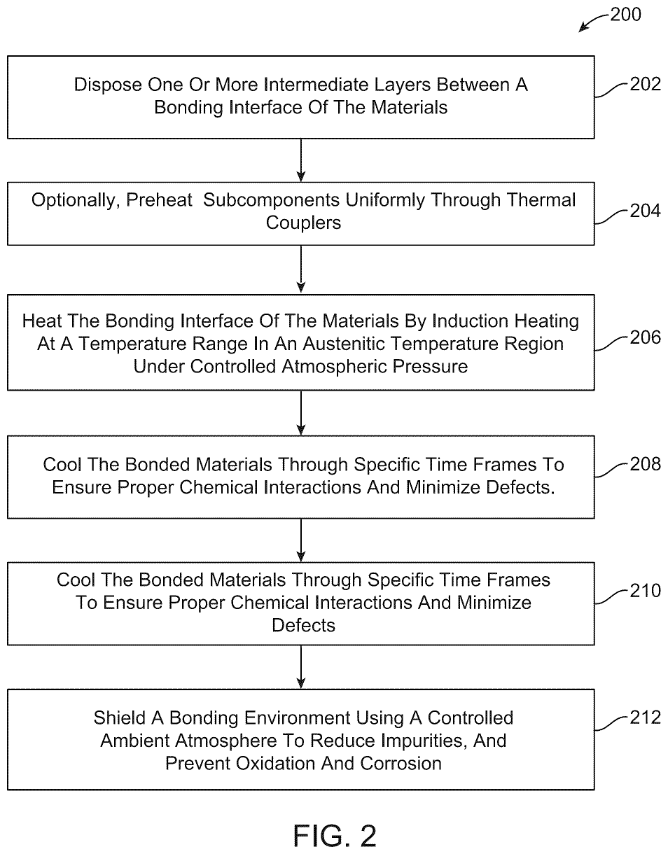

FIG. 2 exemplarily illustrates a method 200 for diffusion bonding of nickel alloy and austenitic stainless steel, according to an embodiment of the present invention. At step 202, one or more intermediate layers are disposed between the boding interfaces of the material to be joined to control thermal gradients and heat transfer direction. The additional intermediate layer has specific thermal conductivity properties. The additional intermediate layer allows for controlled heat transfer towards designated areas. The additional layer creates a gradient that aids in delayed cooling or tempering, enhancing the microstructural properties of the bond. Vacuum quality ionizing bonding can be accomplished if magnetism is performed prior to creating motor-pressure displacement of ambient atmosphere. Fixture and mechanical device can also be utilized alongside magnetism from a tool or die.

At step 204, the subcomponents are optionally preheated uniformly through thermal couplers. If calculating ionizing energy transfer, symmetry of tooling, dies, fixture, final product symmetry allows for clear wave form functions. Preheating can utilize inductance versus magnetism to minimize thermal conduction and resistance preheating.

At step 206, a bonding interface of the nickel alloy and austenitic stainless steel materials and intermediate layers are heated by induction heating. The alloys are heated or reheated into the Austenite region (Y), which helps to relieve residual stresses in the materials. In one embodiment, the materials are heated to a temperature range between 1150° C. and 1300° C. (2100° F. to 2350° F.) in an austenitic temperature region under controlled atmospheric pressure. Optionally, bonding pressure is applied to maintain contact between materials during the bonding process of materials.

At step 208, the bonded materials are cooled through specific time frames. Cooling through the correct regions while limiting specific alloying elements, especially carbon, can control the carbide formations. Temperature regions and time spent within a carbide or precipitate forming region will be monitored.

At step 210, a bonding environment of the bonding process is shielded using a controlled ambient atmosphere. In one embodiment, the bonding environment is shielded introducing shielding gas in the bonding environment. Referring to FIG. 1 and FIG. 2, in one embodiment, the shielding gas includes, but not limited to, hydrogen, CO₂, nitrogen and argon. The shielding gas is configured to protect the bonding environment and influence energy transfer. The shielding gas influences the method by facilitating energy transfer through interactions with wave-particle dynamics. In one embodiment, shielding gases, including, hydrogen, CO₂ and nitrogen promotes desired chemical reactions within the interface including more energy during nucleation at temperature. In another embodiment, hotter or reactive shielding gas creates quicker nucleation and potentially depletion of grains. To hold dimensional or geometric criteria argon could be used as a heavy shielding gas. Excess material removal and surface finish of stainless steel can be processed with no adverse effects. Nickel alloy can absorb elements into precipitates. Absorption of precipitation elements throughout the Nickel alloy are beneficial near interface or intermediate fusion region and surface finish may reduce strength at elevated temperature.

In areas where carbides or precipitates form, additional electrical waveforms, such as those used in radiography, can be applied to analyze and address specific carbide or precipitate patterns. Utilizing argon as a shielding gas offers a more robust solution for producing multiple batches of parts, ensuring better adaptability and scalability. If continuous cooling is not employed, pressure differences must be carefully calculated to optimize energy transfer during the process.

Further, material prone to sensitizing or precipitating due to alloying dilution or diffusion at the interface of the two materials will react as energy levels and internal heat transfer are controlled through electrical inductance. Shielding gas between stainless steel and nickel alloys can be used between an argon gas for shielding from atmosphere until diffusion begins. This creates an inert environment where alloying elements are primarily ionized towards carbide or precipitate formation.

In another embodiment, the bonding environment is shielded using vacuum chambers. According to the present invention, manufacturing in a vacuum ensures tighter control over quality, as the absence of atmospheric gases eliminates the risk of oxidation, contamination, or unwanted chemical reactions. The vacuum environment allows for smaller tolerances, meaning the manufacturing process can produce highly precise and consistent results.

The calculations of energy in a vacuum differ from those in other environments due to the absence of convection. In a vacuum, heat transfer relies solely on conduction within the material and radiation from its surface, leading to localized heating. This requires careful control of energy input to avoid overheating and ensure uniform diffusion. Cooling strategies in such conditions must focus on conduction through contact or radiative cooling, as convection is unavailable to dissipate heat. In yet another embodiment, the bonding environment is shielded using mechanical enclosures.

In one embodiment, pulse width modulation (PWM) and inductance control allow for further refinement of the process by influencing ionization and energy transfer at the bonding interface.

In one embodiment, one or more materials prone to sensitization or precipitation due to alloy dilution at the interface between stainless steel and nickel alloys react based on controlled energy levels and internal heat transfer, which are regulated through electrical inductance. Argon gas could be used as the shielding gas to protect the interface from atmospheric exposure during the process.

To optimize bonding, pulse induction patterns could be analyzed. In one embodiment, a metal alloy may serve as intermediate layers between stainless steel and nickel layer. In another embodiment, the intermediate layer is one or more materials selected from the group consisting of copper, nickel, aluminum, stainless steel, titanium, tantalum, tungsten, iron, lithium, chromium, molybdenum, niobium, zirconium alloy, and mixtures and alloys thereof. In one embodiment, a nickel alloy may serve as intermediate layers between stainless steel and nickel layer. In one embodiment, an austenitic stainless steel may serve as intermediate layers between stainless steel and nickel layer. In another embodiment, the intermediate layer is selected from the group consisting of an austenitic stainless steel of types 301, 304, 304L, 316 and 321, a ferritic steel of types 409 and 430, a high nickel steel alloy of types 625, 600 C276, 860 and 865, a titanium stabilized low carbon steel that meets the 1006 specification, a high carbon steel type 1050, a high strength low alloy (HSLA) steel, a transformation-induced plasticity (TRIP) steel, and a dual phase steel. In one embodiment, alloys like 308L or 309L may serve as intermediate layers between stainless steel and nickel layer. A more specific approach involves concentrating inductive energy directly into the interface to enhance bonding. This method can also be adapted to utilize 308L interface material in lower-temperature forms, such as sheet metal or powder, for efficient diffusion and thermal conduction.

For interfaces involving Inconel and 316L stainless steel, diffusion of elements is carefully monitored to ensure carbide and precipitate formation remains within acceptable ranges. By minimizing alloy dilution and controlling carbide formation, the process achieves a stronger bond with improved structural integrity.

In one embodiment, applying pressure to layers of material can facilitate bonding at lower temperatures, enhancing process efficiency. In one embodiment, pulse width modulation (PWM) and voltage control are configured to energize alloying elements by promoting their ionization. The shielding gas used during the process may be adjusted through a flow regulator and controlled in series with a programmable logic controller (PLC) to optimize the PWM settings. This approach can help identify impurities and detect patterns of chromium depletion, nickel or chromium absorption, as well as carbide and precipitate formation. Even after a process has been fully qualified, additional quality control through radiographic inspection is used to ensure optimal results.

The nucleation of carbides caused by the sensitization of stainless steel is monitored under specific conditions, such as environments with high neutron levels. In such cases, sodium fluid solutions may promote carbide formation, particularly in regions with elevated temperatures or pressure concentrations. However, 316L stainless steel is less prone to additional sensitization after solidification or final hot forming, provided the temperature remains below 400 to 450° C. (750 to 800° F.) at 1 atmosphere.

In corrosive systems subjected to high loads or temperatures, a proper ratio of nickel alloy, such as Inconel, are used to contact any fluid. This ensures better resistance to corrosion and maintains the structural integrity of the material under demanding conditions.

The present invention ensures effective chemistry control by utilizing alloys such as 308L or 309L, or their equivalents, including but not limited to UNS S30800, ASTMA167, ASTM A276, ASTMA314, ASTM A473, ASTM A580, SAE J405 (30308), DIN 1.4303, UNI X 8 CrNi 19 10, JIS SUS 305, JIS SUS 305 J1, or UNS S30900. Additionally, standards like ASME SA249, ASME SA312, ASME SA358, ASME SA403, ASME SA409, ASTM A249, ASTM A312, ASTM A314, ASTM A358, ASTM A403, ASTM A409, ASTM A473, ASTM A511, ASTM A554, ASTM A580, FED QQ-S-763, FED QQ-S-766, MIL SPEC MIL-S-862, SAE J405 (30309), DIN 1.4828, X15CrNiSi2012, UNI X 16 CrNi 23 14, B.S. 309 S 24, PN 86022 (Poland), and H20N13S2 are incorporated to provide a comprehensive framework for material selection.

This invention uses these austenitic alloys with precise control over nickel and chromium equivalents to ensure compatibility and efficiency when employed as intermediate layers. Such meticulous chemistry control aligns with total energy input requirements and optimizes the resulting heat gradient, thus enabling robust diffusion bonding while preserving structural integrity throughout the bonding process.

Referring to FIG. 2, at step 212, a plurality of layers of nickel alloy and austenitic stainless steel materials are bonded to form subcomponents made of nickel alloy and austenitic stainless steel. In one embodiment, multiple layers of subcomponent material could be bonded at elevated temperatures in order to create a solid finished workpiece. In one embodiment, the plurality of layers of materials are bonded using the diffusion welding process. The diffusion welding process involves applying thermal heat and controlled force between the layers to bond and form the subcomponents over a short period of time.

In one embodiment, hot forging processes is used to apply controlled deformation to the material, thereby reducing residual stresses in the final product. In another embodiment, cold forming or hydroforming processes may be applied when full mechanical optimization is not required, allowing for material shaping without focusing on residual stress reduction. The hot forging processes are performed at elevated temperatures to facilitate plastic deformation of the material, ensuring effective reduction of residual stresses while maintaining material integrity. In cases where residual stress optimization is not critical, cold forming or hydroforming processes are used to shape components without concern for residual stresses.

The tooling used in the hot forging process includes hardened tool steel, specifically designed to withstand the elevated temperatures required during the process, ensuring durability and precision. Additionally, ceramic inserts are used within the tooling to ensure precise dimensional control during the hot forging or cold forming process, particularly in areas where tight tolerances are required. The fixturing for the hot forging or cold forming processes is supported by a combination of mechanical fixtures and electromagnetic fixtures, providing enhanced control and stability during material shaping. The mechanical fixtures provide physical support for the material during shaping, while the electromagnetic fixtures aid in controlling heating or positioning of the material, ensuring uniform deformation.

The hot forging process is performed in a controlled atmosphere to prevent oxidation and contamination of the material, ensuring high-quality results and material integrity during residual stress reduction. The tooling includes components specifically designed to optimize heat distribution and force application during the hot forging process, improving material flow and reducing the likelihood of residual stress formation. The cold forming or hydroforming processes are performed at temperatures lower than the austenitic region of the material, ensuring the material does not enter a ductile state that would require stress optimization.

In another embodiment, pressure applied between layers of material facilitates bonding at lower temperatures. Calculations for bonding are optimized near atmospheric pressure (1 atm) while considering time-temperature relationships. When mechanical force, fixtures, dies, or the material's weight applies pressure at the diffusion interface before forming and cooling, the temperatures required for carbide formation are reduced, and precipitate formation is influenced by shorter cooling times. Conducting diffusion and subsequent forming immediately after a continuous casting process minimizes unnecessary thermal cycles, reducing the formation of precipitates and carbides.

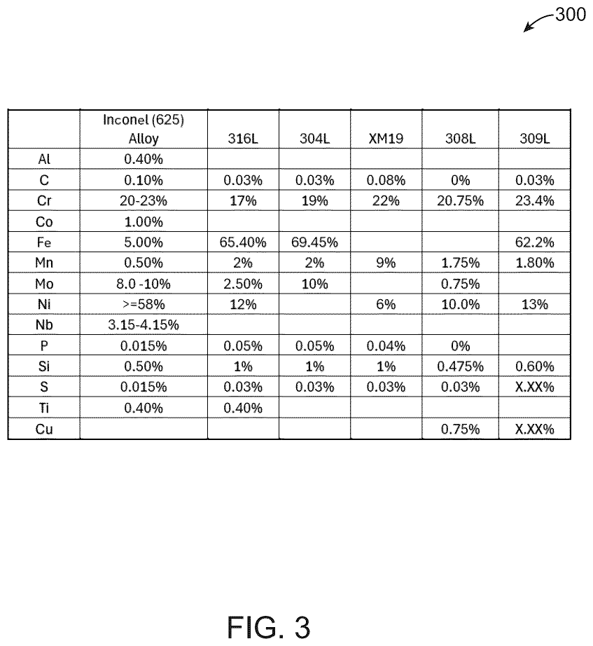

Manufacturing using a single spherical or cylindrical die, with diffusion occurring between layers above the die at the interface and along seams of similar material, is an efficient approach for hot forging or stamping. Continuous casting or spin-form casting of stainless steel is suitable for producing components with rapid diffusion at high temperatures. Examples include materials such as 316L stainless steel and Inconel, which are commonly utilized in industry. Alloying layers at the interface can be selected based on methods that control ferrite numbers, such as using tools like the Scheffler Diagram or WRC-1992 to predict material compatibility. Referring to FIG. 3, the table 300 illustrates the chemical composition of Inconel, 316L stainless steel, and an additional alloying layer, highlighting the differences in alloying elements and their roles in achieving effective bonding and diffusion.

Inconel offers superior strength, particularly at elevated temperatures, along with excellent sodium corrosion resistance. While similar nickel alloys may provide enhanced material properties, they often lack manufacturability, weldability, and cost efficiency. Stainless steels, such as 316L, offer comparable strength and corrosion resistance to nickel alloys while being more economical and easier to work with than carbon steels.

Introducing gases like hydrogen, CO₂, or nitrogen into the bonding environment enables desired chemical reactions at the interface by supplying additional energy during nucleation at elevated temperatures, enhancing the efficiency of the diffusion process.

In yet another embodiment, to achieve specific dimensional criteria, regions can be aligned and coated with ceramics. During the diffusion process, tool steel is utilized to shape the material, ensuring precision and durability. Eddy currents and magnetism are employed to position subcomponents and define the fusion region or interface. The bonding process includes diffusion and forming of multiple layers of subcomponents, such as plate and sheet metal blanks, with material thickness and geometry specified prior to forming. A draw press or forging press may also be used for forming.

For spherical or tubular components, forming is carried out around a tool steel die coated with ceramics. This process incorporates internal tubing to release shielding gas through vents, while surrounding electronics generate electromagnetism to facilitate heat transfer and positioning. The application of piping through the die ensures efficient release of shielding gas.

In one embodiment, the present invention discloses a system for diffusion bonding of nickel alloys and stainless steel materials. The diffusion bonding system for nickel alloys and austenitic stainless steel comprises an inductive heating system equipped with programmable logic controllers to regulate temperature and perform pulse-width modulation for precise heat application. The system includes a vacuum chamber or a gas shielding system to maintain a controlled bonding atmosphere, preventing contamination and oxidation. A mechanical press or forming system applies pressure to the subcomponents during the bonding process, ensuring consistent contact at the interface. The system further comprises sensors and feedback loops to monitor temperature, pressure, and diffusion rates in real time, enabling dynamic adjustments for optimal bonding conditions. Additionally, quality assurance mechanisms are incorporated to detect and minimize defects such as carbides and undesired precipitates at the bonding interface, ensuring the integrity and performance of the final bonded structure.

### EXAMPLES

### Example 1

The energy efficiency range is about how effective the workpiece can be in a vacuum versus with shielding gas as it applies to electromagnetic absorption or radiation. In most environments, it is expected that about 30-50% of the energy is absorbed by the work piece (potentially higher in a vacuum).

A component can be heated to near austenitic temperature through multiple means of heating inductance, thermal coupling, other conduction (combustion), radiation other than inductance (direct energy beams, energy absorbed from magnetism, microwaves etc.), conduction from shielding gas is not in a vacuum. Once near austenitic temperature, utilizing a feedback control loop through a programmable logic controller, energize regions of material to recrystallization. Energy Absorption will be locational based on hardware including voltage tubes, inductance devices, including coils and programmable systems in parallel and series.

Spherical Component Design (Two Hemispheres, 1 m diameter)

| | 1/4 in Inconel | 1/3 in Inconel | 1/2 in Inconel |
|---|---|---|---|
| Interface volume (m³) | 0.0176 | 0.0237 | 0.0364 |
| Weight (kg) | 142 | 192 | 295 |

Tubular or Cylinder Components (1 m diameter)

| | 1/4 in Inconel, | 1/3 in Inconel, | 1/2 in Inconel, |
|---|---|---|---|
| | 1 m length | 1 m length | 1m length |
| Interface volume (m³) | 0.0173 | 0.0231 | 0.0351 |
| Weight (kg) | 140 | 187 | 284 |

In regard to a temper for added precipitate strength, there can be additional time at the range where precipitates would strengthen the alloy after chromium depletion is mitigated (450-600° C.). That would be better to hold for much less than an hour depending on carbide and dislocation location and interface temperature. Additional energy input after the entire work piece is below (650° C.) could add very limited additional strength.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method of diffusion bonding of nickel alloy and austenitic stainless steel materials, comprising:
heating a bonding interface of the materials by induction heating at a temperature range in an austenitic temperature region under controlled atmospheric pressure;
applying a bonding pressure to maintain contact between materials during a bonding process of materials;
cooling the bonded materials through specific time frames to ensure proper chemical interactions and minimize defects, and
shielding a bonding environment using a controlled ambient atmosphere to reduce impurities, and prevent oxidation and corrosion.

2. The method of claim 1, wherein the materials are heated at a temperature range between 1150° C. and 1300° C. (2100° F. to 2350° F.).

3. The method of claim 1, wherein the induction heating is performed using at least one of AC inductance and pulse-width modulation system.

4. The method of claim 1, wherein the bonding environment is shielded using at least one of gas atmosphere, vacuum, and mechanical enclosures.

5. The method of claim 1, further comprising a step of: disposing one or more intermediate layers between the boding interfaces of the material to be joined to control thermal gradients and heat transfer direction before the step of heating the bonding interface.

6. The method of claim 5, wherein the intermediate layer is selected from at least one of 308L and 309L stainless steel alloys in the form of sheet metal or powder, to enhance diffusion and minimize carbide formation.

7. The method of claim 1, wherein the shielding gas is selected from argon, hydrogen, nitrogen, CO₂ or mixtures thereof.

8. The method of claim 1, further comprising a step of:
controlling chemical ranges of the materials to reduce carbides and control alloying elements and precipitates;
controlling cooling rates to regulate carbide formation and precipitate patterns at the bonded interface, and
maintaining the materials within a stable phase region during the bonding process utilizing phase diagrams.

9. The method of claim 8, wherein the cooling rate is controlled through programmable thermal systems to transition the materials through stable regions of the phase diagram, thereby minimizing residual stresses and improving bond strength.

10. The method of claim 8, wherein the regulation of carbide and precipitate formation involves steps of:
selecting shielding gases and adjusting atmospheric conditions to control nucleation at high temperatures;
regulating cooling rates to transition through carbide-sensitive regions of the phase diagram, and
applying energy through induction heating to ensure uniform diffusion and mitigate localized defects.

11. The method of claim 1, further comprising a step of forming and shaping subcomponents of stainless steel and nickel alloys involves steps of:
providing one or more layers of stainless steel and nickel alloy materials with predetermined thickness ratios to form the subcomponents;
applying inductance heating to elevate the temperature of the bonding interface to austenitic ranges;
utilizing one or more mechanical systems to shape and form the subcomponents into a desired geometry during or after the bonding process;
maintaining a controlled atmosphere to prevent contamination during the forming and bonding process;
using ceramic inserts to ensure dimensional precision during the forming process, and
aligning and coating with ceramics for regions being held to specific dimensional criteria.

12. The method of claim 11, wherein the mechanical systems include a combination of hydraulic presses, forging presses, and electromagnetic fixtures to apply controlled pressure during the bonding process.

13. The method of claim 11, wherein the subcomponents are formed using at least one of hot forging processes, cold forming and hydroforming process.

14. The method of claim 1, wherein at least one of pulse width modulation (PWM) and frequency control is performed using digital programmable logic controllers (PLCs) to regulate the heating system across multiple inductance circuits, creating electrical offsets that adjust energy delivery to specific areas of the interface.

15. The method of claim 1, further comprises a step of performing post-bonding quality checks using at least one of radiographic analysis and non-destructive testing methods.

16. The method of claim 1, wherein the nickel alloy comprises Inconel.

17. A method of diffusion bonding of nickel alloy and austenitic stainless steel materials, comprising:
disposing one or more intermediate layers between a boding interface of the materials;
heating the bonding interface of the materials by induction heating at a temperature range in an austenitic temperature region under controlled atmospheric pressure;
applying a bonding pressure to maintain contact between materials during a bonding process of materials;
cooling the bonded materials through specific time frames to ensure proper chemical interactions and minimize defects;
shielding a bonding environment using a controlled ambient atmosphere to reduce impurities, and prevent oxidation and corrosion, and
forming and shaping subcomponents of stainless steel and nickel alloys.
